(19) United States
(12) Patent Application Publication
(10) Pub. No.: US 2006/0037767 A1
(43) Pub. Date: Feb. 23, 2006

(54) Air cylinder for reciprocating pneumatic tool

(76) Inventor: Kuo-Jung Leu, Taichung County (TW)

Correspondence Address: BACON & THOMAS, PLLC, 625 SLATERS LANE, FOURTH FLOOR, ALEXANDRIA, VA, 22314, US

(21) Appl. No.: 11/199,115

(22) Filed: Aug. 9, 2005

(30) Foreign Application Priority Data
Aug. 17, 2004 (TW) 93213111

(51) Int. Cl. B27C 3/08; B23B 45/04

(52) U.S. Cl. 173/169; 227/129

(57) ABSTRACT

An air cylinder installed in a reciprocating pneumatic tool for working with an air valve assembly and a piston to reciprocate a tool bit is disclosed to include a piston tube, which has a piston hole for receiving the piston, a first coupling portion at one end thereof, an air inlet, and an exhaust hole, a outer barrel, which receives the piston tube on the inside and has an air intake passage and an air outlet passage in air communication between the receiving hole of the outer barrel and the air inlet and exhaust hole of the piston tube respectively, and a connector disposed at one end for holding the tool bit for striking by the piston.

### BACKGROUND OF THE INVENTION

1. Field of the Invention

The present invention relates generally to a pneumatic tool and more specifically, to an air cylinder for reciprocating pneumatic tool.

2. Description of the Related Art

The air cylinder of a conventional reciprocating pneumatic tool is a single member made of metal in integrity. This integrated design of metal air cylinder is difficult to manufacture, not suitable for mass production. Further, it is difficult to control the precision of this integrated design of metal air cylinder. A less precision of this integrated design of metal air cylinder may result in an installation failure.

### SUMMARY OF THE INVENTION

The present invention has been accomplished under the circumstances in view. It is one object of the present invention to provide an air cylinder, which can be formed of a plurality of parts to lower processing difficulty and to accelerate manufacturing speed. It is another object of the present invention to provide an air cylinder, which can be conveniently and selectively arranged into one of a variety of forms to fit different requirements. It is still another object of the present invention to provide an air cylinder, which assures positive connection between parts for durable use.

To achieve these and other objects of the present invention, the air cylinder is installed in a reciprocating pneumatic tool for working with an air valve assembly and a piston to reciprocate a tool bit, comprises a piston tube having a piston hole axially extended through two distal ends thereof for receiving the piston, a first coupling portion at one end thereof, an air inlet, and an exhaust hole; a outer barrel has a receiving hole axially extended through two distal ends thereof, an air intake passage in air communication between the receiving hole of the outer barrel and the air inlet of the piston tube, and an air outlet passage in air communication between the receiving hole of the outer barrel and the exhaust hole of the piston tube; and a connector disposed at one end for holding the tool bit for striking by the piston.

### BRIEF DESCRIPTION OF THE DRAWINGS

FIG. 1 is a sectional view showing an air cylinder installed in a reciprocating pneumatic tool according to the present invention.

FIG. 2 is a right side view of the air cylinder according to the present invention.

FIG. 3 is a right side view of FIG. 2.

FIG. 4 is an exploded view in section of the air cylinder according to the present invention.

FIG. 5 is a sectional view of an alternate form of the air cylinder according to the present invention.

FIG. 6 is a sectional view of another alternate form of the air cylinder according to the present invention.

FIG. 7 is a sectional view of still another alternate form of the present invention.

FIG. 8 is a sectional view of still another alternate form of the present invention.

FIG. 9 is a sectional view of a forming structure of the present invention.

FIG. 10 is a sectional view of another forming structure of the present invention.

FIG. 11 is a sectional view of still another forming structure of the present invention.

FIG. 12 is a right side view of another structure of the present invention, showing another layout of the air intake passage and air outlet passage.

### DETAILED DESCRIPTION OF THE INVENTION

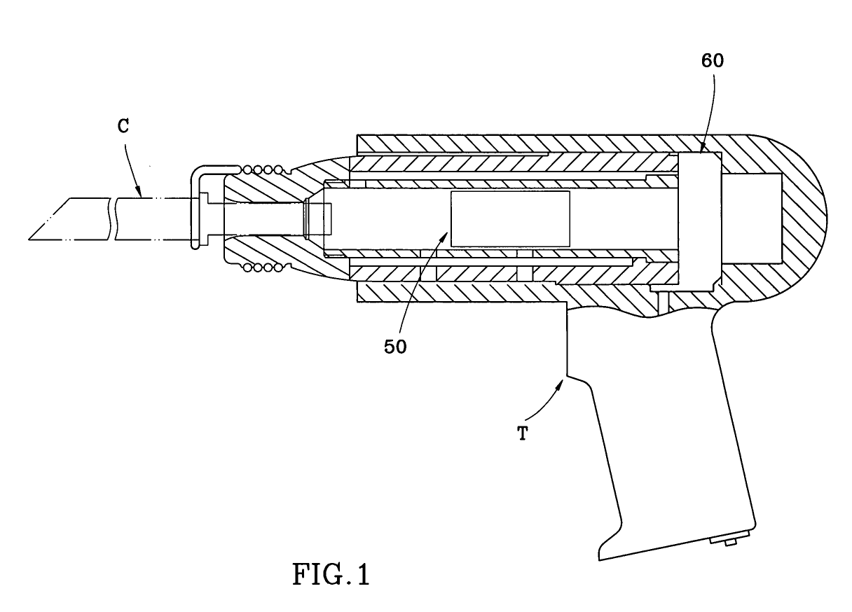

Referring to FIG. 1, an air cylinder in accordance with the invention is shown used in a reciprocating pneumatic tool T and works with a piston 50 and an air valve assembly 60 to reciprocate a tool bit C.

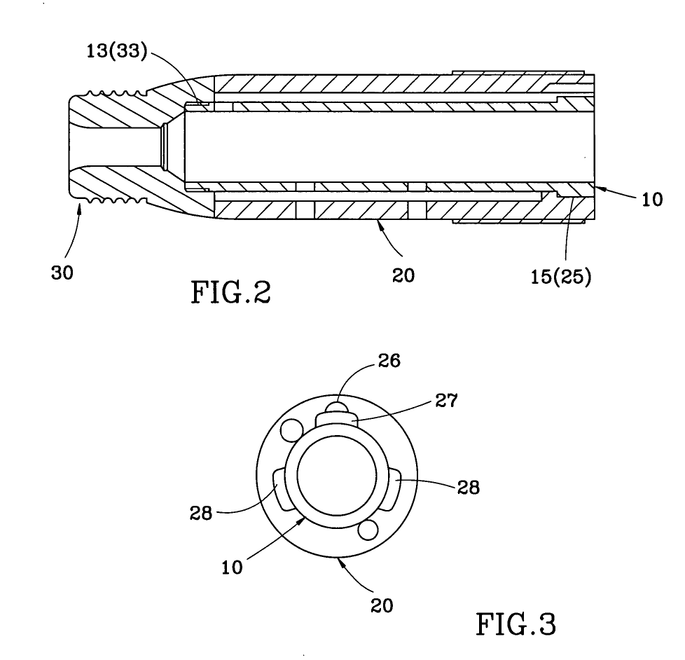

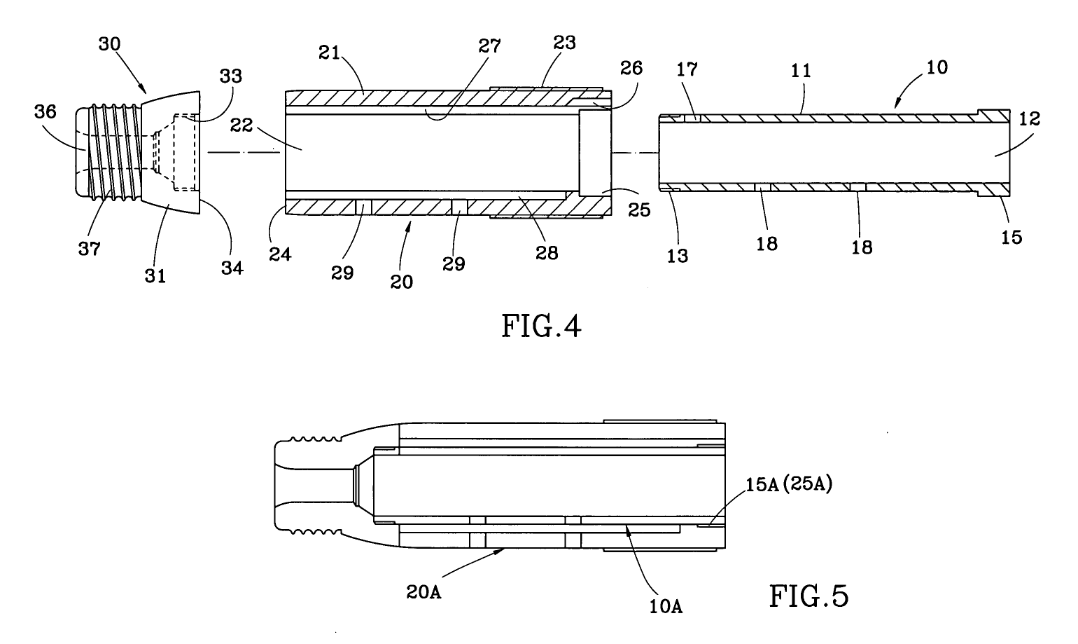

Referring to FIGS. 2-4, the air cylinder is comprised of a piston tube 10, an outer barrel 20, and a connector 30.

The piston tube 10 has a tubular body 11, a piston hole 12 axially extended through the two distal ends of the tubular body 11 within which the piston 50 is moved, a first coupling portion 13, which is an outer thread extended around the periphery of one end of the tubular body 11, a second coupling portion 15 at the other end of the tubular body 11 around the periphery, an air inlet 17, and a plurality of exhaust holes 18.

The outer barrel 20 has a barrel body 21, a receiving hole 22 axially extended through the two distal ends of the barrel body 21 for accommodating the piston tube 10, a handle mounting portion 23, for example, an outer thread extended around the periphery of the barrel body 21 near one end, a stop edge 24 at the front end of the barrel body 21, a coupling portion 25 at the other end of the barrel body 21 within the receiving hole 22 for receiving the second coupling portion 15 of the piston tube 10, an air inlet 26, an air intake passage 27 and two air outlet passages 28 arranged in parallel in the barrel body 21 in air communication with the receiving hole 22, and two exhaust holes 29 respectively disposed in communication between the air outlet passages 28 and the outside of the barrel body 21.

The connector 30 has a connector body 31, a coupling portion 33, for example, an inner thread formed in one end for threading onto the first coupling portion 13 of the piston tube 10, a stop edge 34 for stopping against the stop edge 24 of the outer barrel 20, a receiving hole 36 axially extended through the two distal ends, and a threaded neck 37 for the mounting of a tool adaptor to hold the tool bit C.

During operation of the pneumatic tool T, compressed air passes through the air valve assembly 60 and the air intake passage 27 of the outer barrel 20 into the air inlet 17 and the piston hole 12 to move the piston 50 backwards. When the piston 50 reached the air valve assembly 60 during return (backward) stroke, compressed air passes directly from the air valve assembly 60 into the piston hole 12 instead to move the piston 50 forwards, thereby causing the piston 50 to strike against the tool bit C. This reciprocating motion is repeatedly again and again.

FIG. 5 is a sectional view of an alternate form of the present invention. According to this embodiment, the second coupling portion 15A of the piston tube 10A is an outer thread, and the coupling portion 25A of the outer barrel 20A is an inner thread adapted to receive the second coupling portion 15A of the piston tube 10A.

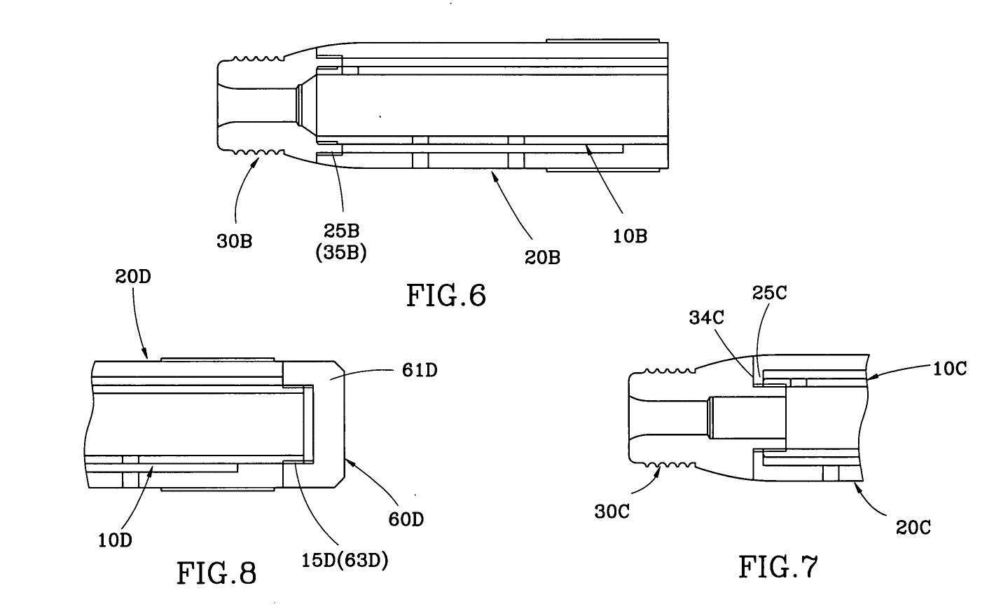

FIG. 6 is a sectional view of another alternate form of the present invention. According to this embodiment, the connector 30B has a second coupling portion 35B, which is an outer thread; the coupling portion 25B of the outer barrel 20B is an inner thread formed in one end for threading onto the second coupling portion 35B of the connector 30B.

FIG. 7 is a sectional view of a part of still another alternate form of the present invention. According to this embodiment, the connector 30C has a stop edge 34C, which is a stop flange formed in the rear end; the coupling portion 25C of the outer barrel 20C is a coupling flange formed in the front end for engagement with the stop edge 34C of the connector 30C.

FIG. 8 is a sectional view of a part of still another alternate form of the present invention. According to this embodiment, the second coupling portion 15D of the piston tube 10D is an outer thread; the air valve assembly 60D has an inner thread 63D threaded onto the second coupling portion 15D of the piston tube 10D, the end of the outer barrel is pressed by the air valve assembly 60D.

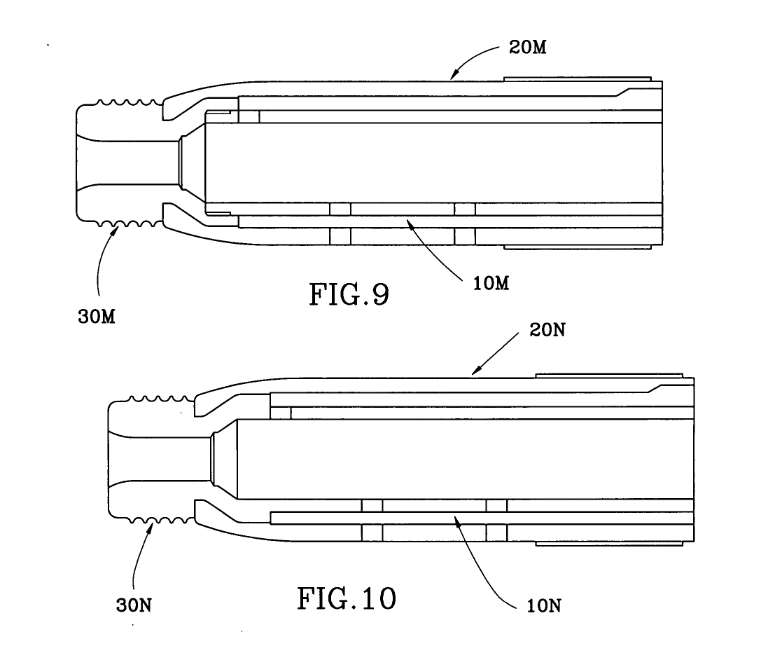

FIG. 9 is a sectional view of a forming structure of the present invention. According to this embodiment, the outer barrel 20M is injection-molded from plastics on the periphery of the piston tube 10M and the periphery of the rear part of the connector 30M. Alternatively, the outer barrel can be sealed.

FIG. 10 is a sectional view of another forming structure of the present invention. According to this embodiment, the piston tube 10N is formed integral with the rear part of the connector 30N.

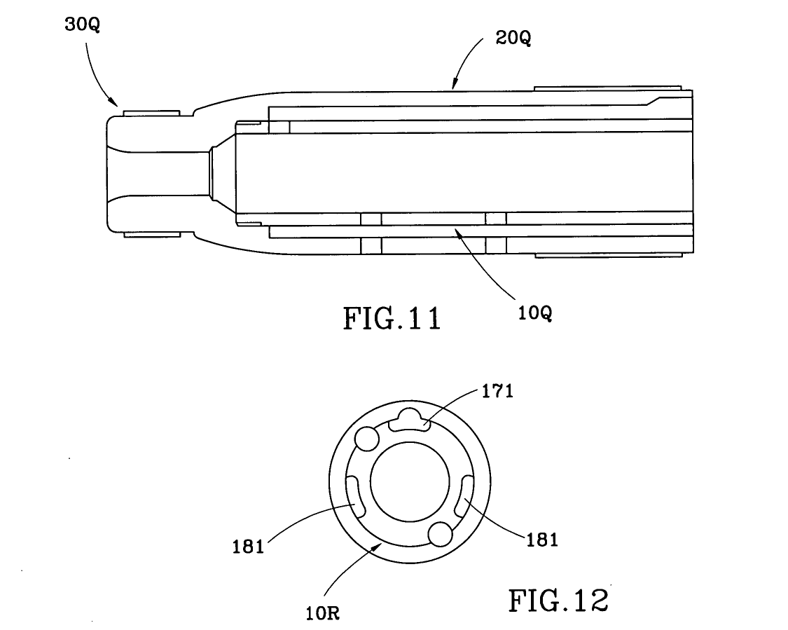

FIG. 11 is a sectional view of still another forming structure of the present invention. According to this embodiment, the outer barrel 20Q and the rear part of the connector 30Q are injection-molded integral from plastics and then sealed to the periphery of the piston tube 10Q.

FIG. 12 is a right side view of another structure of the present invention. According to this embodiment, the air intake passage 171 and air outlet passages 181 are respectively formed in the periphery of the piston tube 10R.

Further, latching, grinding, or punching technique can make the second coupling portion of the piston tube.

Further, gasket rings or sealing rubbers may be used to seal gaps between the parts of the air cylinder.

As indicated above, the invention has the following advantages:

1. The air cylinder can be formed of a plurality of parts to lower processing difficulty and to accelerate manufacturing speed.

2. The combination design of the air cylinder can be conveniently and selectively arranged into one of a variety of forms to fit different requirements.

3. The combination design of the air cylinder assures positive connection between parts for durable use.

What is claimed is:

1. An air cylinder installed in a reciprocating pneumatic tool for working with an air valve assembly and a piston to reciprocate a tool bit, comprising:
a piston tube having a piston hole axially extended through two distal ends thereof for receiving said piston, a first coupling portion at one end thereof, an air inlet, and an exhaust hole;
a outer barrel having a receiving hole axially extended through two distal ends thereof, an air intake passage in air communication between said receiving hole of said outer barrel and said air inlet of said piston tube, and an air outlet passage in air communication between said receiving hole of said outer barrel and said exhaust hole of said piston tube; and
a connector disposed at one end for holding said tool bit for striking by said piston.

2. The air cylinder as claimed in claim 1, wherein at least two of the three members of said piston tube and said outer barrel and said connector are fastened together by one of the fastening measures including screw joint, rivet joint, butt joint, welded joint and sealing.

3. The air cylinder as claimed in claim 2, wherein the connection between parts include the connection between said piston tube and said outer barrel, the connection between said outer barrel and said connector, and the connection between said connector and said piston tube.

4. The air cylinder as claimed in claim 1, wherein at least two of the three members of said piston tube and said barrel and said connector are formed integral with each other, and the integrated connection between parts include the connection between said piston tube and said outer barrel, the connection between said outer barrel and said connector, and the connection between said connector and said piston tube.

5. The air cylinder as claimed in claim 1, wherein at least one of said piston tube and said outer barrel and said connector is injection-molded from plastics and connected with at least one another.

6. The air cylinder as claimed in claim 1, wherein said piston tube and said outer barrel and said connector are injection-molded from plastics and formed integral with one another.

7. The air cylinder as claimed in claim 1, wherein said piston tube and said outer barrel are fixedly connected by said air valve assembly.

8. The air cylinder as claimed in claim 1, wherein said piston tube and said outer barrel each have stopping means respectively stopped against each other.

9. The air cylinder as claimed in claim 1, wherein said outer barrel has an exhaust hole for exhaust of air out from said piston tube.

10. The air cylinder as claimed in claim 1, wherein said air intake passage and said air outlet passage are formed in one of said piston tube and said outer barrel.
